(19) United States
(12) Patent Application Publication
(10) Pub. No.: US 2012/0116955 A1
(43) Pub. Date: May 10, 2012

(54) CHARGING PURCHASES TO UTILITY ACCOUNTS

(75) Inventors: Ronald D. Prosser, Huntington Beach, CA (US); Victor Shao, Mountain View, CA (US)

(73) Assignee: The Prosser Group LLC, Huntington Beach, CA (US)

(21) Appl. No.: 12/939,406

(22) Filed: Nov. 4, 2010

(51) Int. Cl. G06Q 40/00

(52) U.S. Cl. 705/39

(57) ABSTRACT

Charging purchases to utility accounts including a computer program product that stores instructions for implementing a method. The method includes receiving a request from a consumer at an electric vehicle charging station to charge at least one of a purchase of electrical power for electric vehicle (EV) charging and an item other than electrical power to an electrical power utility account. The method also determines if the consumer is authorized to charge the purchase to the electrical power utility account. A transaction denied message is transmitted to the consumer in response to determining that the consumer is not authorized to charge the purchase to the electrical power utility account. The method further includes, in response to determining that the consumer is authorized to charge the purchase to the electrical power utility account: charging the purchase to the electrical power utility account; and transmitting a transaction completed message to the consumer.

### BACKGROUND OF THE INVENTION

The present invention relates generally to charging purchases to existing utility accounts and more particularly to charging purchases of items other than utilities to existing utility accounts.

Due to rising cost of petroleum and the fuels derived from it, the desire to improve efficiency to reduce air pollutants, and increasingly more restrictive regulatory requirements, the automotive industry has developed new types of vehicles that utilize a combination of power sources to provide the necessary energy for the propulsion of vehicles. Rather than rely solely on an internal combustion engine, these new vehicles, referred to as hybrid vehicles, utilize an internal combustion engine in combination with an electric motor. Another version called a plug-in electric vehicle may also supplement the charging of the batteries from the electric grid or other sources. Depending on the mode of operation, the vehicle will use the combustion engine, the electric motor, or a combination thereof. By using the electric motor at various times, the combustion engine could be shut off, reducing the amount of gasoline or other fuel consumed using electricity to power the motor instead. The electric motor is powered by batteries that are periodically recharged through a combination of a generator coupled to the combustion engine, regenerative breaking technology and from the local utility grid or other external source of electricity. Regenerative breaking allows the capture of energy that would otherwise be dissipated through heat when the vehicle is slowed down or brought to a stop. A third type of vehicle, a pure electric vehicle, also referred to as an all-electric vehicle, eliminates the internal combustion engine and relies solely on stored electrical energy in the vehicle batteries.

Pure electric vehicles add complications over hybrid electric vehicles, in that pure electric vehicles require significantly more electricity than hybrid vehicles. A typical hybrid electric vehicle requires a charge of 2-3 kilowatt hours (KWH) of electricity. In contrast, pure electric vehicles, such as the Nissan Leaf (manufactured by the Nissan Motor Company) for example, may require 20 KWHs of energy storage and future vehicles are envisioned to require charging in excess of 50 KWHs. Level 1 chargers and Level 2 chargers are adequate to provide this level of charge. Level 3 chargers are now available in the range of 150 plus KWs and charging stations of 1,000 KW to 1,500 KW (1-1.5 MW) are expected to be available in the near future.

Plug-in electric vehicles provided many advantages over internal combustion engine vehicles and previous generations of all-electric vehicles. The plug-in electric vehicle provides greater range and more flexibility for the operator. Since the all-electric vehicle needed to be charged periodically, and required several hours at a minimum to recharge, the operator needed to remain aware of the level of charge remaining in the batteries to ensure they were able to return to their charging station. Plug-in electric vehicles, in contrast, by having two different sources of propulsion do not carry the same risks due to the wide availability of fuels such as gasoline.

A typical plug-in electric vehicle uses a Lithium Ion or nickel metal hydride battery or the like to store electrical charge. When run in pure electric mode, the plug-in electric vehicle can only operate for short distances, 2 km-32 km for example, before requiring the use of the gasoline engine. Since the gasoline engine recharges the batteries, at least in part, the vehicle manufacturers need to balance the amount of battery storage against fuel efficiency to provide a vehicle that meets the consumer's performance expectations.

The plug-in electric vehicles include a receptacle that connects the batteries to a standard 110V or 220V household electrical outlet and allows the consumer to recharge the batteries using utility electric power rather than by burning gasoline or other fuel in a combustion engine. This allows the plug-in electric vehicles to have a longer range in electric mode of operation since larger capacity batteries may be used, resulting in vehicle that uses less gasoline and thus lower emission. It should be appreciated that all-electric vehicles have similar features, albeit without the internal combustion engine.

In addition to household electrical outlets, consumers may also use electric vehicle charging stations (EVCSs) to charge the batteries in their plug-in electric vehicles and all-electric vehicles. EVCSs may be located at locations such as commuter parking lots, gasoline stations, grocery stores and convenience stores. As battery technology improves pure electric vehicles (EVs) will emerge requiring greater electrical charges and their owners will desire these charges to occur fast. These stations may provide fast charging capabilities and draw much greater current. It is envisioned that while these stations may start small many will grow to have up to six or eight Level 3 chargers each in the 400 to 480 volt and up to 200 KW of power more range and in aggregate providing 1 MW of power or more at the charging station vs. today's hybrid electric chargers providing 110 volt and around 1 KW of power. In addition to selling electrical power, some of these locations may be selling additional items such as food, magazines, and wireless fidelity (WiFi) access. The electrical power provided to the vehicle by the EVCS may be billed to the consumer's existing utility account for electrical power usage at the consumer's residence or business. This capability, of allowing a consumer to bill an existing utility account for a utility (e.g., electrical power) received at a utility replenishment station is suitable for its intended purpose, however there remains a need for expanding this capability to allow the consumer to charge items other than the utility to an existing utility account.

### BRIEF DESCRIPTION OF THE INVENTION

According to one aspect of the invention, a computer program product for charging purchases to utility accounts is provided. The computer program product includes a tangible storage medium readable by a processing circuit and storing instructions for execution by the processing circuit for performing a method. The method includes receiving a request from a consumer at an electric vehicle charging station to charge at least one of a purchase of electrical power for electric vehicle (EV) charging and an item other than electrical power to an electrical power utility account. The method also determines if the consumer is authorized to charge the purchase to the electrical power utility account. A transaction denied message is transmitted to the consumer in response to determining that the consumer is not authorized to charge the purchase to the electrical power utility account. The method further includes, in response to determining that the consumer is authorized to charge the purchase to the electrical power utility account: charging the purchase to the electrical power utility account; and transmitting a transaction completed message to the consumer.

According to another aspect of the invention, a method of charging purchases to utility accounts is provided. The method includes receiving a request from a consumer at an electric vehicle charging station to charge at least one of a purchase of electrical power for electric vehicle (EV) charging and an item other than electrical power to an electrical power utility account, the receiving at a host system via a network. It is determined, at the host system, if the consumer is authorized to charge the purchase to the electrical power utility account. A transaction denied message is transmitted, via the network, to the consumer in response to determining that the consumer is not authorized to charge the purchase to the electrical power utility account. The method further includes, in response to determining that the consumer is authorized to charge the purchase to the electrical power utility account: charging the purchase to the electrical power utility account; and transmitting a transaction completed message, via the network, to the consumer.

According to another aspect of the invention, a computer program product for charging purchases to utility accounts is provided. The computer program product includes a tangible storage medium readable by a processing circuit and storing instructions for execution by the processing circuit for performing a method. The method includes receiving a request from a consumer to charge a purchase of an item other than a utility to a utility account. The method also determines if the consumer is authorized to charge the purchase to the utility account. A transaction denied message is transmitted to the consumer in response to determining that the consumer is not authorized to charge the purchase to the utility account. The method further includes, in response to determining that the consumer is authorized to charge the purchase to the utility account: charging the purchase to the utility account; and transmitting a transaction completed message to the consumer.

According to a further aspect of the invention, a method of charging purchases to utility accounts is provided. The method includes receiving a request from a consumer to charge a purchase of an item other than the utility to a utility account, the receiving at a host system via a network. It is determined, at the host system, if the consumer is authorized to charge the purchase to the utility account. A transaction denied message is transmitted, via the network, to the consumer in response to determining that the consumer is not authorized to charge the purchase to the utility account. The method further includes, in response to determining that the consumer is authorized to charge the purchase to the utility account: charging the purchase to the utility account; and transmitting a transaction completed message, via the network, to the consumer.

According to a further aspect of the present invention, a system for charging purchases to utility accounts is provided. The system includes a host computer and an application for execution on the host computer to implement a method. The method includes receiving a request from a consumer to charge a purchase of an item other than a utility to a utility account, the receiving via a network. It is determined if the consumer is authorized to charge the purchase to the utility account. A transaction denied message is transmitted, via the network, to the consumer in response to determining that the consumer is not authorized to charge the purchase to the utility account. The method further includes, in response to determining that the consumer is authorized to charge the purchase to the utility account: charging the purchase to the utility account; and transmitting a transaction completed message, via the network, to the consumer.

According to a further aspect of the present invention, a method of charging purchases to utility accounts is provided. The method includes receiving a request from a consumer to charge a purchase of an item other than a utility to a utility account, the receiving via a user interface at a client system. Identifying data about the consumer is received. The request and the identifying data is transmitted, via a network, to a host system. A status message is received from the host system. The status message is one of a transaction completed message and a transaction denied message. The transaction completed message indicates that the purchase of the item was charged to the utility account and that the purchase of the item is complete. The transaction denied message indicates that the purchase of the item was not charged to the utility account and that the purchase of the item is not complete. The status message is output to the consumer via the user interface.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a block diagram of a system upon which utility account charging services may be implemented in an exemplary embodiment;

FIG. 2 illustrates a flow diagram of a process for processing a charge to a utility account in an exemplary embodiment;

FIG. 3 illustrates a flow diagram of a process for initiating a charge to a utility account in an exemplary embodiment;

FIG. 4 illustrates a flow diagram of a process for charging a purchase to an existing utility account in an exemplary embodiment:

FIG. 5 illustrates a flow diagram of an exemplary embodiment of a process for initiating a charge to a utility account;

FIGS. 6-7 depict block diagrams of an Utility Transaction Fee EZ Charge business model that may be implemented by an exemplary embodiment;

FIGS. 8-15 depict various use cases for the Utility Transaction Fee EZ Charge business model that may be implemented by an exemplary embodiment;

FIGS. 16-17 depict block diagrams of a Subscribing Utility Network (SUN) EZ Pass System business model that may be implemented by an exemplary embodiment;

FIGS. 18-25 depict various use cases for the SUN EZ Pass System business model that may be implemented by an exemplary embodiment;

FIGS. 26-27 depict block diagrams of an All Prepaid Transaction (APT) EZ Charge business model that may be implemented by an exemplary embodiment; and

FIGS. 28-35 depict various use cases for the APT business model that may be implemented by an exemplary embodiment.

The detailed description explains embodiments of the invention, together with advantages and features, by way of example with reference to the drawings.

### DETAILED DESCRIPTION OF THE INVENTION

An exemplary embodiment of the present invention provides commercial charging of electric vehicles (EVs), including billing of the electric charging, payment of federal and state fuel taxes, security, e-marketing, premium add-on services, and other point of sale services. Exemplary embodiments include the use of a smart card payment system, credit card payment, cash payment, advanced purchase magnetic cards, bar code cards or other printed material, radio frequency identification (RFID) devices, and other payment devices. Exemplary embodiments include methods for collection and disbursement associated with these transactions including the capability for billing EV charging and other non-utility related transactions directly to a utility bill, smart card, pre paid magnetic card, bar code device or RFID device for participating utilities and commercial establishments.

For example, a consumer may go to a convenience store, such as 7-11, or to a quick service restaurant (QSR), such as a Starbucks, a 7-Eleven, or Burger King for example, where a charging station exists and receive an electric charge for a vehicle. This may lead to a broader set of non-utility related transactions which could be included on the electric vehicle operator's utility bill, prepaid card, bar coded device, or other payment method. For example, if the consumer buys 10 kilowatt hours (KWH) of electrical charge, he may also buy other non-utility related goods and services. These other goods and services may include wireless fidelity (WiFi) connectivity service while the vehicle is being charged and/or purchases within the store while the EV is being charged. Currently, there is a transaction fee (e.g., approximately 2%) for credit card purchases. As described herein, a customer would decide how to pay, and in an exemplary embodiment, if the consumer elects to have the purchase billed to his utility bill, the transaction fee would be attached to applicable purchases and shared between the local utility and other participating entities. Exemplary embodiments include the use of smart “controllers” within electric vehicle charging stations (EVCS) designed to interoperate and work in a hierarchal system that provides for seamless operation of EV charging programs across regions (e.g., utility company defined regions, states, counties, countries). EV charging programs may include, but are not limited to: prepaid programs, discounted rate programs, and billed to the home utility programs. In an exemplary embodiment, the system implemented by the controllers is interoperable with a system that manages the loads of the electrical distribution system. Both systems may use the same family of controllers, may have the same cyber security systems, data archival and retrieval systems, data discovery systems, and work on a publish subscribe basis.

An exemplary embodiment provides a consumer with the ability to charge the purchase of items other than a utility to an existing utility account. As used herein, the term “utility” refers to a commodity that is provided to a consumer by a utility provider. Utility providers generally provide a commodity product that is sold to the general public within a local or regional area. The products and services provided by utility providers include, but are not limited to: electrical power, natural gas, oil, city water, cable television, and telephone service. Generally, there are only a single or small group of utility companies within a local or regional area and the operations of a utility company may be regulated by governmental agencies. In regions where production of electricity is deregulated, the utility provider may be an energy producer (e.g., an electrical generator) or an electrical distribution provider. As used herein, the term “utility account” refers to an account set up by a utility provider in order to track utility usage/consumption at a physical location, and to bill a responsible party (e.g., a consumer) for the utility usage. In the past, the utility account was associated with consumption at a fixed location, such as a customer's home for example. As used herein, the term “electric vehicle” or “EV” refers to any type of vehicle that utilizes electric power, such as but not limited to: pure electric vehicles, hybrid vehicles, and plug in hybrid-electric vehicles.

In an exemplary embodiment, the utility is electrical power, and the utility provider is an electrical distribution company. In an example scenario, a consumer is using an electric vehicle charging station (EVCS) located at a convenience store to charge the batteries in his plug-in electric vehicle. While waiting for the batteries to charge, the consumer may purchase some items at the convenience store (e.g., lunch and a newspaper). According to exemplary embodiments described herein, the consumer can purchase the items by charging them to an existing electrical power utility account that was previously set up to bill the consumer for electrical power usage at the consumer's home (or other location). In an exemplary embodiment, the consumer purchases the items directly through a user interface on the EVCS. This provides a convenient manner for the consumer to purchase the items; for example, the consumer can avoid having to wait in line at the convenience store and does not need to carry extra cash or a credit card in order to make purchases.

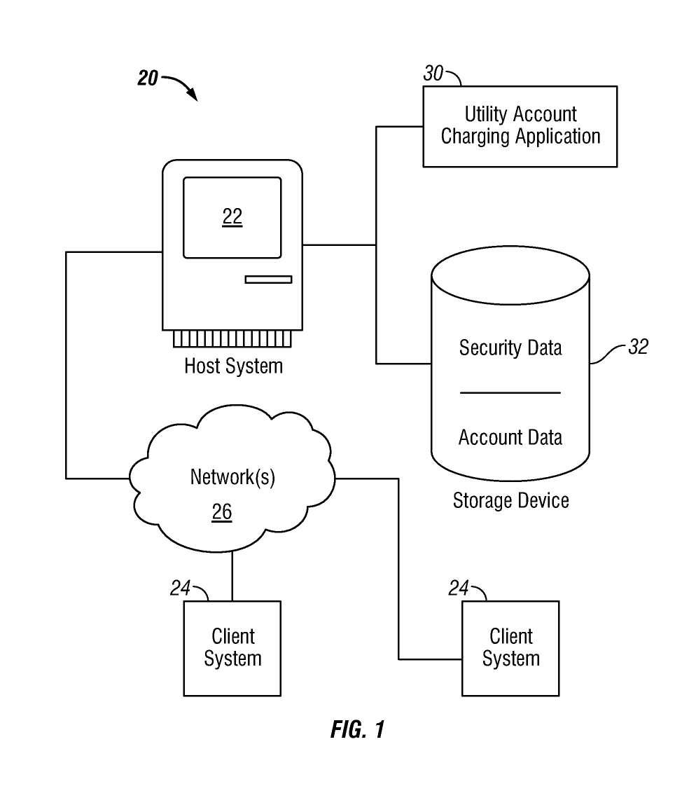

FIG. 1 depicts a block diagram of a system 20 upon which utility account charging services may be implemented in an exemplary embodiment. The system 20 of FIG. 1 includes a host system 22 in communication with client systems 24 via one or more network(s) 26. Host system 22 may be implemented using one or more servers operating in response to a computer program stored in a storage medium accessible by the server(s). The host system 22 may operate as a network server (e.g., a web server) to communicate with one or more client systems 24. The host system 22 may handle sending and receiving information to and from client systems 24 and may perform associated tasks.

The host system 22 may also operate as an application server. In accordance with exemplary embodiments, the host system 22 executes one or more computer programs to provide utility account charging services to a consumer at a client system 24. These one or more computer programs are referred to collectively herein as a utility account charging application 30. In an exemplary embodiment, the utility account charging application 30 interfaces with an existing utility account billing application executing on a utility provider computer system to track and bill for utility usage at a residence or business location. In an alternate exemplary embodiment, the host system 22 executes the utility provider's utility account billing application and the utility account charging application 30 is integrated into the utility provider's account billing application.

In an exemplary embodiment, a portion of the functionality of the utility account charging application 30 is implemented via the client systems 24 by providing an application (e.g., java applet) to the client systems 24. Alternatively, client systems 24 include stand-alone software applications for performing a portion of the processing described herein. In yet further embodiments, the utility account charging services functionality is be built into a web browser application executing on the client systems 24 (not shown). As previously described, it is understood that separate servers may be utilized to implement the network server functions and the application server functions of host system 22. Alternatively, the network server and the application server may be implemented by a single server executing computer programs to perform the requisite functions described with respect to host system 22.

Client systems 24 may be coupled to host system 22 via one or more network(s) 26. Each of the client systems 24 may be implemented using a general-purpose computer executing a computer program for carrying out some of the processes described herein. The client systems 24 may be personal computers (e.g., a lap top, a personal digital assistant) or host-attached terminals. In an exemplary embodiment, a utility account charge initiating application executes on the client systems 24 to initiate charging a purchase to a utility account. In an exemplary embodiment, the client systems 24 are utility provider devices, such as utility replenishment stations (e.g., EVCSs). In an exemplary embodiment, the client systems 24 include a user interface for receiving input from and providing output to a consumer.

In an exemplary embodiment, the utility account charging services system 20 shown in FIG. 1 includes a storage device 32. Storage device 32 is in communication with host system 22 and may be implemented using a variety of devices for storing electronic information. It is understood that the storage device 32 may be implemented using memory contained in the host system 22 or it may be a separate physical device, e.g., as shown in FIG. 1. The storage device 32 is logically addressable as a consolidated data source across a distributed environment that includes network(s) 26. Information stored in the storage device 32 may be retrieved and manipulated via the host system 22 and authorized users of client systems 24. The storage device 32 may house security data for the utility accounts, and data about the accounts (e.g., current balance, payment history, usage history, etc.), among other information utilized by the service provider of host system 22. In an exemplary embodiment, the host system 22 operates as a database server and coordinates access to application data including data stored on storage device 32.

Network 26 may be any type of known network including, but not limited to, a wide area network (WAN), a local area network (LAN), a global network (e.g. Internet), a virtual private network (VPN), and an intranet. The network 26 may be implemented using a wireless network or any kind of physical network implementation known in the art. Client systems 24 may be coupled to the host system 22 through multiple networks (e.g., intranet and Internet) so that not all client systems 24 are coupled to the host system 22 through the same network. One or more of the client systems 24 and the host system 22 may be connected to the network(s) 26 in a wireless fashion.

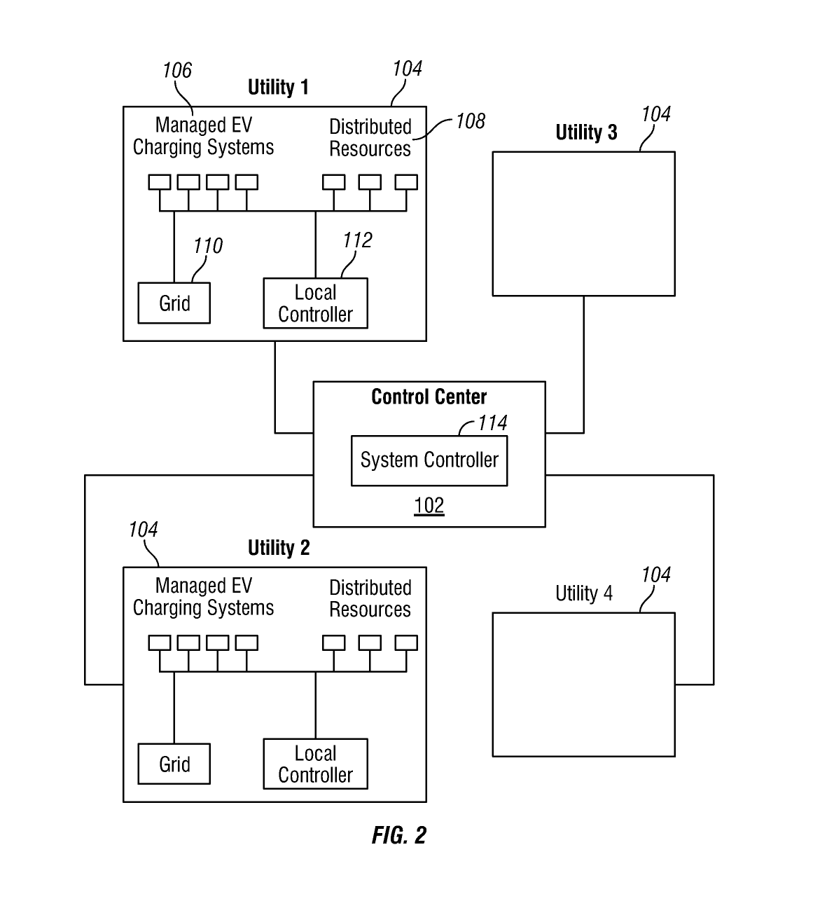

FIG. 2 is a block diagram of a system of controllers that may be implemented by an exemplary embodiment. Shown in FIG. 2, are several local controllers 112 (implemented, for example, by host systems 30) each associated with a utility provider for providing the utility (e.g., electrical charge) to a group of EVCSs 106 (implemented, for example, by client systems 24). The local controllers 112 communicate (e.g., via a network, such as network 26) with a system controller 114 located in a control center 102 in order to determine if a consumer is authorized to charge a purchase to an account at another utility. For example, a local controller 112 may be associated with a first utility provider (e.g., utility 1 104) and a consumer has request that a charge be applied to an account associated with second utility provider (e.g., utility 2 104). In an exemplary embodiment, the local controller 112 associated with the first utility would request authorization from the second utility provider by communicating via the system controller 114 to a local controller 112 associated with the second utility provider.

The local controllers 112 depicted in FIG. 2 are designed to manage over all transactions associated with EV charging at specific locations. The local controllers 112 are utilized to establish methods for collection and disbursement associated with these transactions including billing non-utility related transactions in addition to EV charging directly to the utility bill, smart card, pre paid magnetic card, bar code device or RFID device for participating utilities and commercial establishments. In addition, energy efficiency and load curtailment may be systemically integrated into the system. For example local electrical congestion may necessitate curtailment of electric vehicle charging at a particular location. In this case the system notifies the customer in advance or during the charging period of the need to limit EV charging to a determined amount. This may be based on EV operator contract status (e.g. executive platinum), state of charge (provide sufficient charge to ensure EV has ample charge to make it to alternative charging stations), and price. The system will notify customer of alternative charging locations available to make a charge and relevant information such as wait time, price, map with alternative locations, driving instructions and specific available payment options at the alternate locations. The system depicted in FIG. 2 is referred to herein as the “EZ Charge system”, and it implements functions referred to herein as “EZ Charge.”

An embodiment of the EZ Charge system includes the ability to provide charging station companies with financial incentives to engage in energy efficiency programs to reduce peak loads across the system and on specific secondary feeders that may become electrically congested at critical times. This may involve actions such as, but not limited to: curtailment of load, use of renewable energy (e.g. local solar photovoltaic (PV)), energy storage, and credits for carpooling. In an exemplary embodiment, a representative from the control center 102 in combination with one or more of the local utilities will identify credits or abated rates as appropriate to large company and small company providers and embed these credits into their consolidated billings.

In an exemplary embodiment, the local controller 112 is also utilized to manage the electrical load on a secondary grid or region. By performing these two functions on the same controller, energy efficiency programs are seamlessly integrated into the EV charging infrastructure in a way that gracefully scales to millions of nodes.

As depicted in FIG. 2, the EZ Charge system includes a system of hierarchical controllers (e.g., local controllers 112 and system controllers 114) that allow the EZ Charge system to scale to millions of nodes, to interoperate across the systems and to communicate with multiple utilities and customers seamlessly. The modular software system enables multi-faceted customer programs to occur, evolve, be added, or be eliminated. In an exemplary embodiment, the EZ Charge system is remotely upgraded with new software. In the exemplary embodiment depicted in FIG. 2, each “island” within the EZ Charge system is made up a region 104 associated with a utility. A region 104 serviced by a utility may include managed EVCSs 106, distributed resources 108 (e.g., convenience stores, QSRs), and a grid 10 for providing the electricity. The structure depicted in FIG. 2 allows a finite number of transactions to be accommodated within each island. Transactions between islands occur at the next hierarchal level, via the system controller 114 at the control center 102. In this manner the communication, memory, and command and control requirements are finite and manageable.

Though, the EZ Charge system depicted in FIG. 2 includes only two levels of hierarchy, it is expected that other exemplary embodiments will include more than two levels of hierarchy to facilitate communication across regions. In addition, the islands depicted in FIG. 2 are regions 104 that correspond to utility companies. The regions 104 may be selected based any combination of other criteria, such as, but not limited to state boundaries, and other geographic or business unit boundaries. At one level in the hierarchy, the regions 104 may correspond to utility companies, at the next level the regions 104 may be grouped based on state boundaries and at a third level the states may be grouped into geographic location.

In an exemplary embodiment, aspects of the EZ Charge system have a common architectural framework that allows interoperability of the system between the regions 104. The local controllers 112 are built to the substantially same software and hardware architecture. It should be appreciated that in some embodiments, the local controllers 112 may have localized software components and the interoperability is achieved through a common application program interface (API). The software is modular and service based. Interface requirements are identified and published. An interoperability function is provided in each local controller 112 enabling it to interact with legacy systems and other local controllers 112. The interoperability service is also capable of being remotely upgraded. The interoperability service allows translation to be available across the system to facilitate communication with legacy or other systems. This allows an EV charging station in Chicago to interoperate with an EV owner's home utility account in New York to provide seamless coverage to the customer. In this case, the service is requested on one island; a communication link is established via a secure communication system to another island; authentication is provided on this second island as is approval for the transaction; and the transaction is then completed. Both islands have near identical local controllers 112. The higher tier hierarchy (e.g., the system controller 114 at the control center 102) provides access to discovery services, data routing, publish subscribe services, data archival and retrieval service and other unique capabilities required to enable rapid secure transactions between the islands.

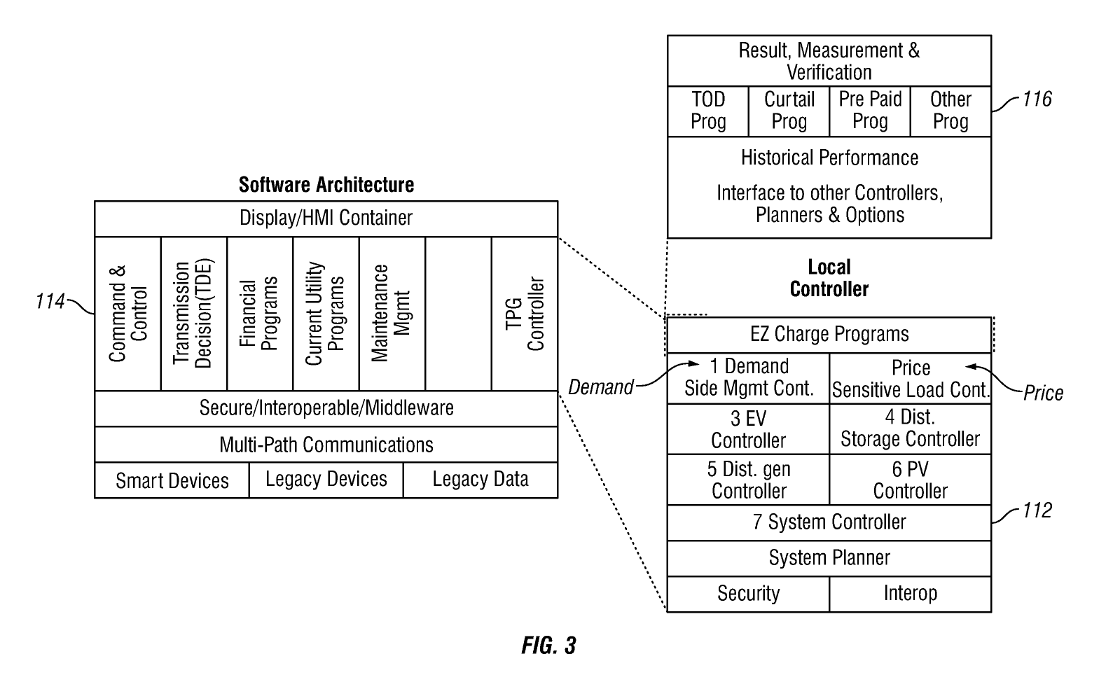

FIG. 3 depicts a modular software architecture of a system controller 114 that may be implemented by an exemplary embodiment. As shown in FIG. 3, the system controller 114 that may be implemented by an exemplary embodiment. As shown in FIG. 3, the system controller 114 is located in the control center 102 and includes the software utilized by a local controller 112 located in a region 104 defined by a utility. Also as depicted in FIG. 3, the local controller 112 includes payment software to facilitate consumer payment for goods and services. The modular software architecture depicted in FIG. 3 allows new programs to be readily integrated into the system as they become available. Each software module comes with interoperability capability that allows it to plug into existing systems and to communicate over a common communication infrastructure with maximum reuse of existing capability. This facilitates the flow of information within a utilities service region and between utility service regions. Commercial business providing EZ Charge service as part of a broader offering to consumers (e.g. a large company such as Safeway) can interoperate with multiple utilities across a region or the country. The business can seamlessly interoperate between stores in a chain where similar programs are implemented. For example, a store may elect to provide free charging services after 5 pm or on weekends in order to attract consumers to the store.

In an exemplary embodiment, a highly controlled computer security and communications system (“cybersecurity system”), such as that defined by the International Organization for Standardization (“ISO”) standard 27007, the North America Electric Reliability Corporation (“NERC”) standard 1300 for example, is utilized to provide data protection. In an exemplary embodiment, features of the security system include, but are not limited to, at least one of: role based access control which is robust, flexible and need to know based; integrity of data and commands provided via secure encrypted links; subject authorization which enables public key infrastructure (PKI) authentication; intrusion detection which provides early identification of cyber intrusion attempts and effective anti-worm signatures and certificates; and defense in depth enabling early detection and response. Exemplary embodiments of the EZ Charge system are designed to allow the modular architecture to morph into alternate modules and hence change over time.

In an exemplary embodiment, the system controllers 114 are capable of remotely updating the firmware at the local controllers 112 by sending an over-the-air-programming (OTAP) command. The executable update send by the OTAP command is encrypted before it is sent. Upon receipt, and prior to self-updating, the package is decrypted and the checksum verified. This OTAP process is agnostic to the actual communication medium. System problems can be fixed and the fixes distributed easily, and new functionality can be added. For example, a utility may add a new energy efficiency program. The change to the system can be easily and readily accommodated. Similarly, a business may elect to introduce a promotional program or new functionality.

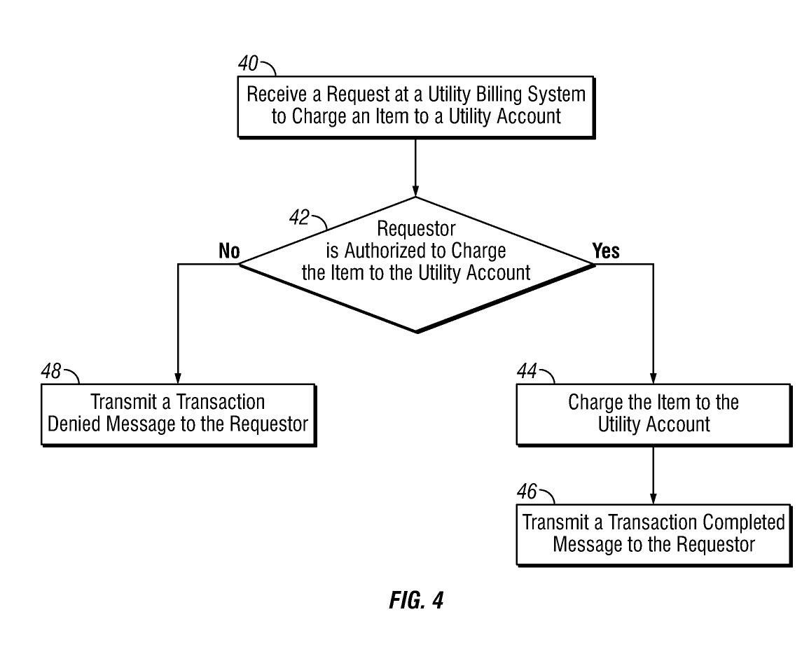

FIG. 4 illustrates a flow diagram of a process for charging a purchase to an existing utility account in an exemplary embodiment. In an exemplary embodiment the processing depicted in FIG. 4 is implemented by the utility account charging application 30 executing on the host system 22 (e.g., by the system controller 114). At block 40, a request is received at the utility account charging application 30 to charge a purchase of an item other than a utility to an existing utility account. Examples of items other than a utility include consumable items such as food, and beverages and newspapers, and services such as network connection services (e.g., WiFi connection to the Internet) and cellular telephone services. In an exemplary embodiment, the request is received from a consumer who is located at a utility replenishment device, such as an EVCS, and the request is received via the network(s) 26.

At block 42, it is determined if the consumer is authorized to charge the purchase to the utility account. If the consumer is not authorized to charge the purchase to the utility account, then block 48 is performed and a message indicating that the transaction was denied is transmitted to the consumer via the network(s) 26. If the requestor is authorized to charge the purchase to the utility account, then block 44 is performed and the item is charged to the utility account to add the purchase price of the item(s) to the consumer's utility account bill. A message indicating that the transaction has been completed is transmitted to the consumer at block 46.

In an exemplary embodiment, the utility account is an established utility account that reflects utility usage at a residence or a business location. In an exemplary embodiment, the utility account tracks utility usage at the consumer's residence.

In an exemplary embodiment, identifying data is received from the consumer and used to verify that the consumer has access to the utility account for charging an item other than the utility. The identifying data may be compared with security data associated with the utility account. In an exemplary embodiment, the determining performed at block 42 is performed in response to the identifying data and the security data. In an exemplary embodiment, the identifying data and the security data is compared, and if they match the consumer is authorized to charge the item to the utility account. Identifying data is any data that may be used to uniquely identify the consumer, such as, but not limited to, a password, a security code, a fingerprint, and a social security number, for example.

In an exemplary embodiment, the determining performed at block 42 is also responsive to at least one of a current payment status of the utility account and a current balance of the utility account. In an exemplary embodiment, if the current balance of the utility account is over a specified limit, then no more items other than a utility can be charged to the utility account. In another exemplary embodiment, if payment of the utility account is past due by a specified number of days, then no more items other than a utility can be charged to the utility account. In other exemplary embodiments, a combination of the current payment status and the current balance of the utility account are utilized to determine if the consumer is authorized to charge an item other than a utility to the utility account.

In an exemplary embodiment, the utility is electric power. In this embodiment, a request to charge the purchase of an item other than electrical power to an electrical power utility account is received at an electrical power utility account charging application system. The request is from a consumer at an EVCS. It is determined, by the electrical power utility account charging application, whether the consumer is authorized to charge the purchase to the electrical power utility account. A transaction denied message is transmitted to the consumer in response to determining that the consumer is not authorized to charge the purchase to the electrical power utility account. The purchase is charged to the electrical power utility account and a transaction completed message is transmitted to the consumer in response to determining that the consumer is authorized to charge the purchase to the electrical power utility account.

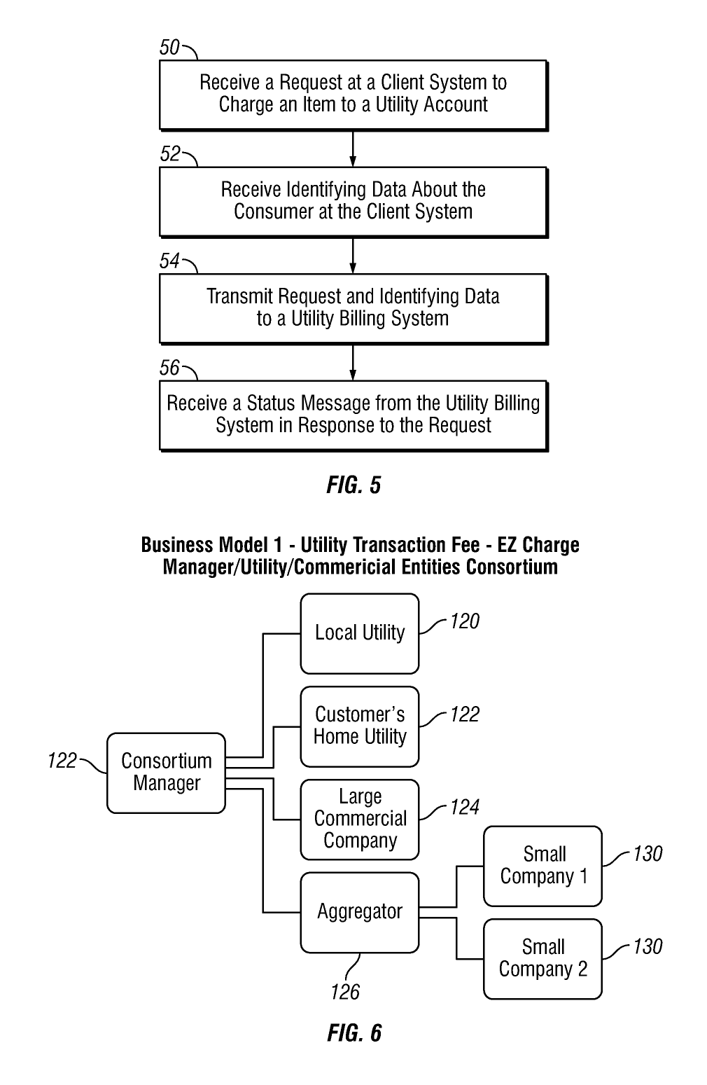

FIG. 5 illustrates a flow diagram of an exemplary embodiment of a process for initiating a charge to a utility account. In an exemplary embodiment, the processing depicted in FIG. 5 is implemented by a utility account charge initiating application executing on a client system 24 (e.g., by the local controller 112). At block 50, a request to charge an item other than a utility to a utility account is received at a client system 24. The request is received from a consumer via a user interface device on the client system 24. At block 52, identifying data about the consumer is received at the client device. As described previously, identifying data is any data that may be used to uniquely identify the consumer. At block 54, the request and identifying data are transmitted to a utility account charging application 30 executing on the host system 22 via the network(s) 26. At block 56, a status message is received from the utility account charging billing application 30. The status is either that the transaction was completed or that the transaction was denied. The transaction completed message indicates that the purchase of the item was charged to the utility account and that the purchase of the item is complete. The transaction denied message indicates that the purchase of the item was not charged to the utility account and that the purchase of the item is not complete. The message is output to the consumer via the user interface on the client system.

In another embodiment, the cost of electrical power consumed by the consumer's vehicle may be small. In this embodiment, the consumer receives electrical power for free when a certain amount of products are purchased from the retail establishment. Alternatively, the consumer may receive the electrical power for free or at a reduced charge when the consumer purchases selected promotional items at the retail establishment. In another alternative, the consumer may receive the electrical power for free or at a reduced charge when the consumer shops at the retail establishment during particular hours.

In another embodiment, the consumer may receive an incentive, such as a coupon for example, such as from their utility or the retail establishment to entice them to go to the EVCS. For example, the consumer may receive the electrical power for free or at a reduced charge when the coupon is presented and/or when the consumer purchases particular items at the retail establishment.

The following describes an example sequence of steps during a typical transaction.

An EV driver initiates a transaction at a public charging station (e.g., an EVCS) by presenting a home utility issued payment card or device such as a radio frequency identification (RFID) key fob.

The EV driver enters a personal identification number (PIN).

The EVCS terminal encrypts the information and transmits it to a system controller 114 at the control center 102 requesting authorization to proceed.

The system controller 114 at the control center 102, having the lookup table for all participating members and their designated processors, forwards the transaction information to the correct local controller 112 that is processing transactions on behalf of the home utility.

The local controller 112 authenticates the transaction credentials (e.g., active account, correct PIN) and responds back to system controller 114 with “approved” or “declined”. If the response is “approved”, then the response includes an authorization code and the maximum spending limit for electricity purchase, as well as any pre-paid funds usable for goods and services.

The system controller 114 forwards the response back to the local controller 112 at the EVCS. The entire authentication process takes a few seconds.

If approved, the EV driver is prompted to couple the connector (e.g., the SAE J1772 connector) and receptacle, and charging for the EV begins.

If one of these conditions is met, the transaction is considered complete: the connection between the connector and receptacle is broken as indicated by the J1772 pilot signal; the EV is fully charged and stops accepting power; power to the vehicle is turned off at the EVCS; or the maximum spending limit is reached.

During and after EV charging completion and before finalizing the transaction, the driver can purchase additional goods and services in the same transaction.

The EVCS encrypts the transaction information including KWH transferred, the cost per KWH, and an itemized list of additional goods and services and their costs to the system controller 114 at the control center 102.

In an exemplary embodiment, the system controller 114 runs an automated settlement process every day and debits the account holders' home utility account for electricity purchased, and any goods or services purchased against pre-paid funds in the account; credits the local utility (where service was rendered) for electricity purchased (minus fees); credits the EVCS operator (large commercial entity or an aggregator of EVCSs) a transaction fee for distributing the electricity (minus fees); credits the EVCS operator (large commercial entity or an aggregator of EVCSs) for goods and services purchased during the transaction (minus fees); credits the operator of the control center 102 for ongoing operational fees. Note that in an exemplary embodiment, the control center 102 is not a holding bank, and all credits and debits are settled instantaneously

In an exemplary embodiment, the system described herein ties together all the marketing and point of sales features into a single system and provides the products and services to the consumer through payment using cash, credit card or direct payment to the consumers' utility bill. In an exemplary embodiment, the system is flexible and it facilitates the user and the stakeholder being able to have choices in how they execute transactions on the system.

In an exemplary embodiment, a utility implements a system where individual utilities can set many of their own customer account policies. For example, these could include a refundable deposit or a nonrefundable charge for a pre-paid magnetic card, RFID tag, bar code ticket, periodic maintenance fees, paper statement fees, the low account threshold, and replenishment amounts. The EZ charge would be offered as a debit account where charging fees are deducted from prepayments. In an exemplary embodiment, utilities can allow users to choose to have prepayments automatically deposited when their account is low, or submit prepayments manually. These could involve use of a credit card having a transaction fee or potentially charged directly to the user's utility bill.

In an exemplary embodiment, individual utilities can offer unique discounted tolls to EZ charge customers including general discounts for all EZ charge users, variable pricing discounts for off-peak hours, commuter programs with minimum usage levels, flat rate plans offering unlimited use for a period of time, and local resident plans for those living near particular charging station facilities. These plans may only be available to customers of a particular utility and only be applicable in that service area or they may be broadly adopted.

In an exemplary embodiment, providers within a utility's service area can allow users to utilize EZ Charge products and services. However, companies could also develop products unique to their charging station establishments. In an exemplary embodiment, subsidized EV charging is provided. Individual establishments such as Starbucks or 7-Eleven can capture a business advantage by offering subsidized charging in order to gain further sales of their basic goods and services. Prepayment instruments can be used not just for charging but also for purchase of goods and services at their establishments. In the case of provider unique payment devices, the provider would pay the local utility separately for KWH used.

In an exemplary embodiment, companies are able to participate in unique energy efficiency programs which result in credits or abated electrical rates.

In an exemplary embodiment, a broad set of transactions can be included on the EV operator's utility bill. A consumer may stop at a 7-Eleven or other store for 20 minutes to buy 10 KWH of electrical charge, and he may also buy other goods and services. These may include WiFi connectivity service while the vehicle is being charged and/or purchases within the store while the EV is being charged.

Currently, there is a transaction fee (e.g., 2%) for credit card purchases. In an exemplary embodiment, if the consumer elects to have a purchase charged to his utility bill, then a transaction fee would be attached to applicable purchases and shared between the local utility and other participating entities. An exemplary embodiment includes consumer friendly communications, notifications and alerts, e.g., via a mobile telephone or via an EVCS display screen. For example, if an electrical outage or local peak load issue were to impact one or several stores, then curtailment of an EV charging sale could be made at the affected stores but not at any others. Automatic notification to the stores and EV users could be sent automatically providing instructions as to what nearby stores were unaffected by the event along with maps and other relevant information.

Following are three example methods of implementing transactions. One of these processes may be implemented by a utility or coalition of utilities, and participating commercial entities could manage these transactions. Various combinations of these processes are possible in addition to variations of functional assignments within each of the three. Each method accounts for paying the utility for KWH charges including time of day charge and energy efficiency/demand-response credits, and fuel taxes as applicable for example. They include: Utility Transaction Fee EZ Charge; Subscribing Utility Network EZ Pass; and All Prepaid Transactions (APT) EZ Charge for example.

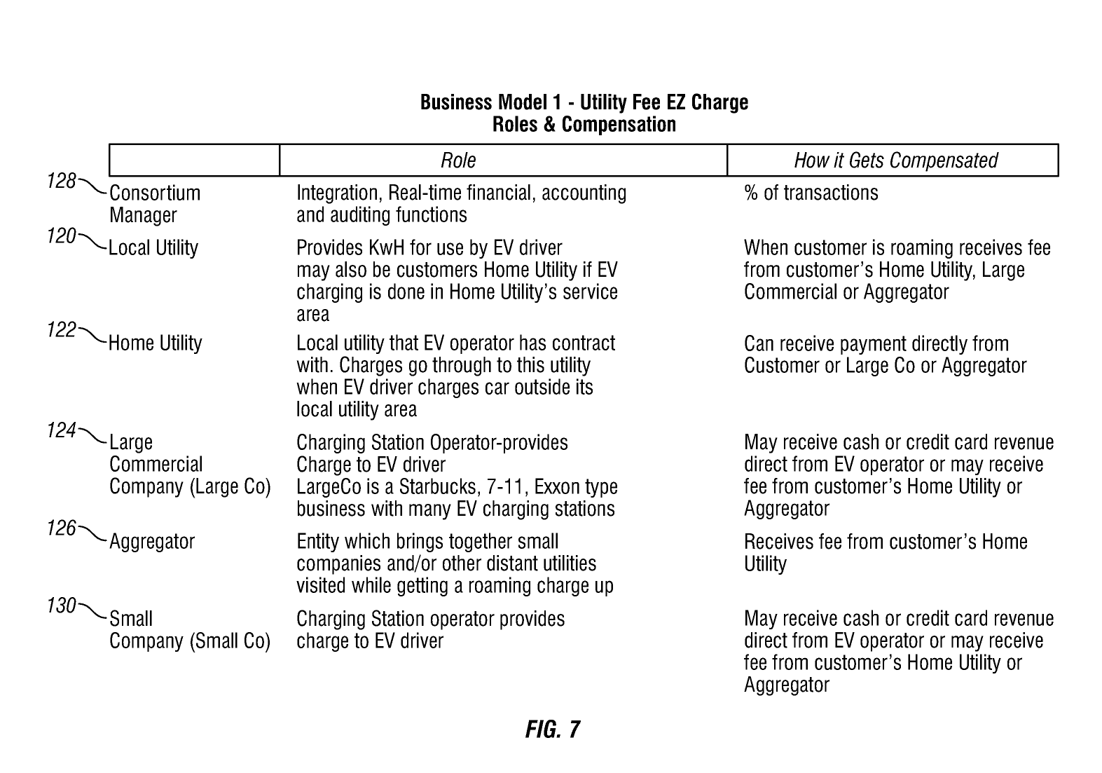

The first process, the Utility Transaction Fee EZ Charge, differs from the other two processes in at least two ways: first, it is based on having a transaction fee roughly equivalent to a credit card charge (e.g. Master Card or Visa) that the utility would assess for handling certain transactions; and second, these transactions are limited to high KWH EV users across the utility's service area or transactions with neighboring utilities, thus ensuring the utility a high margin return. It is important to create an enduring financial instrument for utilities to use to defray EV charging implementation costs and to minimize or eliminate the impact of these programs on existing rate payers who may not be or ever become an EV owner. As depicted in FIGS. 6 and 7, a group may include participating utilities (local utility 120, customer's home utility 122), larger commercial companies 124 (e.g. 7-11, Exxon-Mobile Corporation, etc.), a commercial aggregator of smaller commercial entities (aggregator 126), smaller commercial companies 130 (e.g., regional grocery stores), and a consortium manager 128.

Participating utilities are at times in the service area providing the EV charge referred to as the local utility 120 and the utility that has a contract with the EV operator is referred to as the home utility 122. Generally these “two” utilities will be one and the same, however, they may be different as EVs commute or “roam” across utility service areas. The consortium manager 128 is responsible for the overall functioning and integration of the system. In this example, EV operators make payments through a smart utility card, RFID, a pre-paid card, or bar coded device. Payments related to EV charging or other goods and services would, with appropriate approvals, be made directly to a consumer's utility bill. This could include EV charging and paying directly to the local utility 120 via a smart card, an advanced payment magnetic card, an RFID based payment, and potentially a prepaid bar coded device. Payments may also be made by the EV operator directly to the EVCS operator by credit card, cash, pre-paid magnetic card, barcode device and may include promotional discounts or “free charging”.

In the case of the EV payments going to the EV operator's utility bill, the local utility 120 makes appropriate payments directly to large commercial companies 124, other utilities, taxing authorities, the consortium manager 128, and the aggregator 126. The local utility 120 would not make direct payments to the plethora of small commercial entities, or to “distant utilities”, whose region an EV operator may have traveled throughout, but that the local utility 120 doesn't do significant business with. These off normal transactions would be paid by an aggregator 126 that is efficient in handling massive numbers of small transactions. The aggregator 126 is also responsible for making payments to smaller companies 130. Consequently, the utility's transaction each month remains manageable (target less than 50). The local utility 120 would pay federal and state fuel taxes on miles driven by EVs in its service area. The consortium manager 128 is responsible for integration across the system, providing automated accounting of transactions required by all the stakeholders to execute the program and providing an independent audit function. Transactions not charged directly to a utility bill will be accounted for by the commercial entities providing the service and paid directly to the appropriate utility, road improvement tax authority, or other entity.

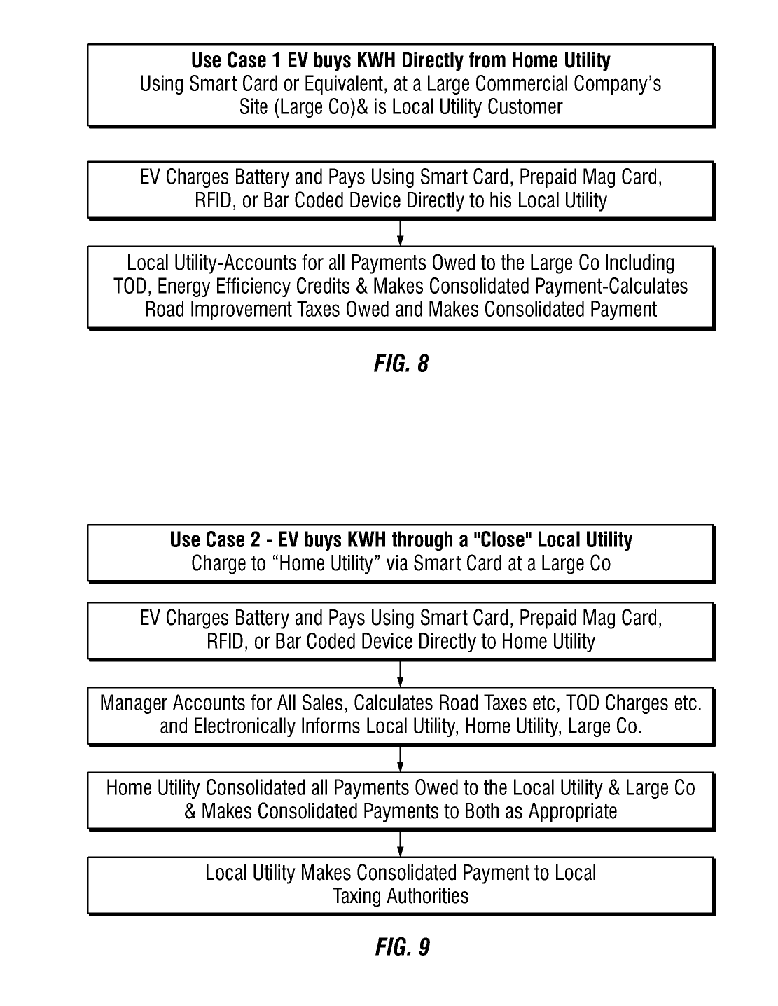

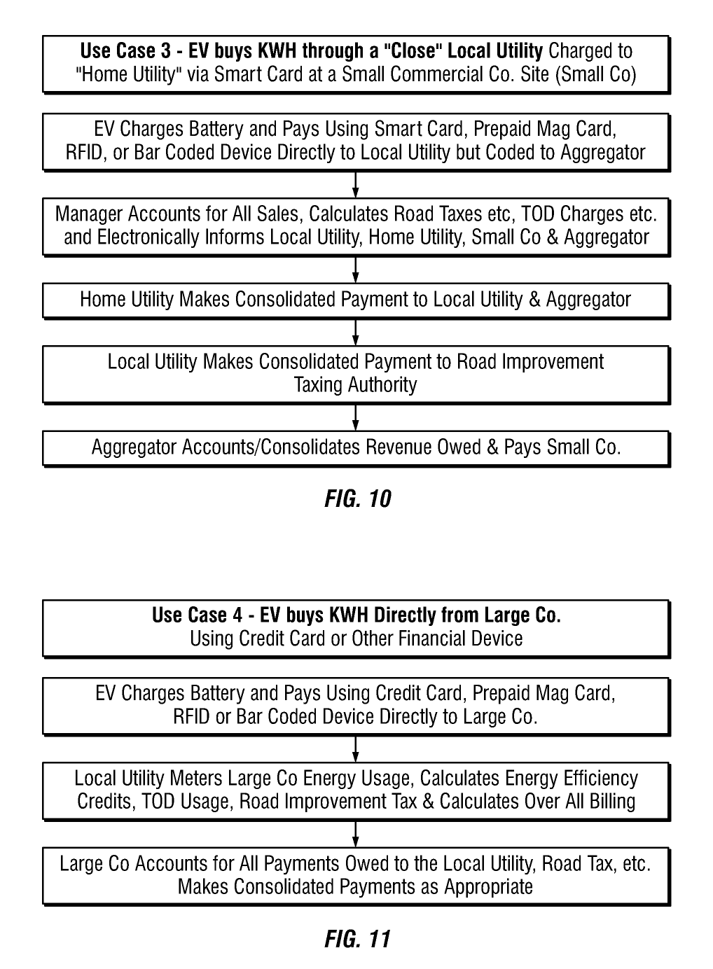

FIGS. 8-15 depict various use cases for the Utility Transaction Fee EZ Charge business model. The use cases described herein are illustrative of a family of use cases and do not represent all use cases covered by exemplary embodiments. FIG. 8 depicts a first exemplary use case, where an EV operator buys KWH directly from his home utility 122 using a smart card or equivalent, at a large commercial company's site (large commercial company 124) and the EV operator is a customer of the local utility 120. FIG. 9 depicts a second exemplary use case, where an EV operator buys KWH through a close local utility 120 and charges the purchase to a home utility 122 via a smart card at a large commercial company 124. FIG. 10 depicts a third exemplary use case, where an EV operator buys KWH through a close local utility 120 and charges the purchase to a home utility 122 via a smart card at a small company 130.

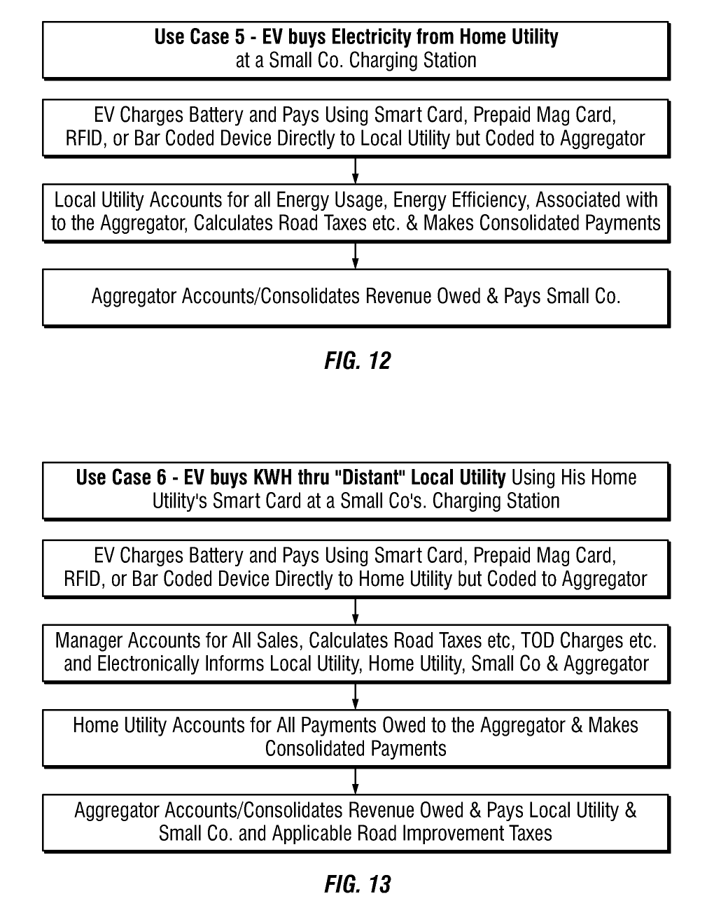

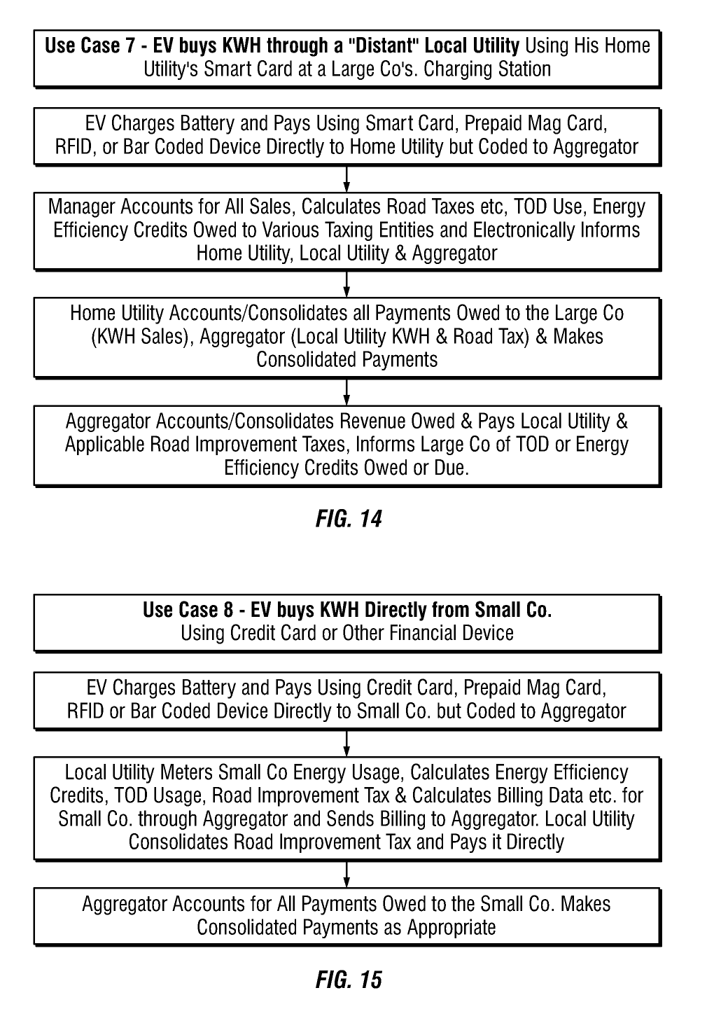

FIG. 11 depicts a fourth exemplary use case for the Utility Transaction Fee EZ Charge business model, where an EV operator buys KWH directly from a large commercial company 124 using a credit card or other financial device. FIG. 12 depicts a fifth exemplary use case, where an EV operator buys electricity from a home utility 122 at a small company 130 EVCS. FIG. 13 depicts a sixth exemplary use case, where an EV operator buys electricity from a distant local utility 120 using a smart card from his home utility 122, where the purchase is at a small company 130 EVCS. FIG. 14 depicts a seventh use case, where an EV operator buys KWH through a distant local utility 120 using a smart card from his home utility 122, where the purchase is a large commercial company 124 EVCS. FIG. 15 depicts an eighth exemplary use case where an EV operator buys KWH directly from a small company 130 using a credit card or other financial device.

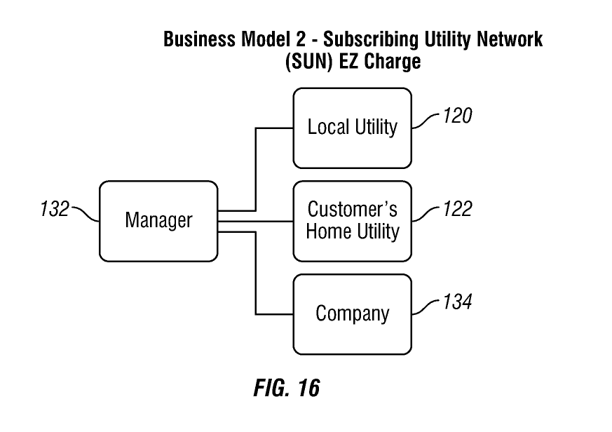

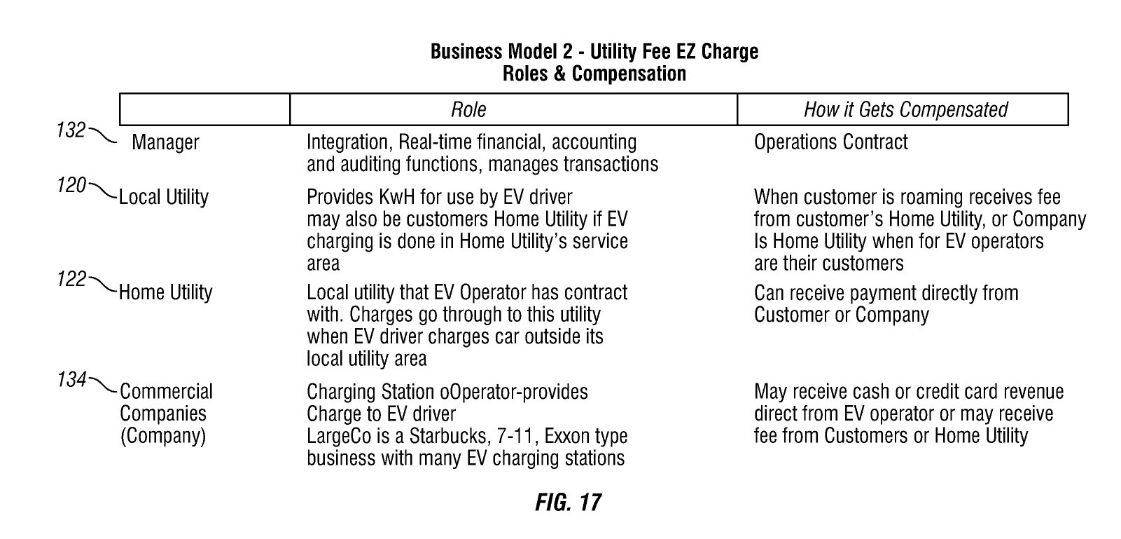

The second business model is the Subscribing Utility Network (SUN) EZ Pass. The SUN EZ Pass model is similar to the EZ Pass system (e.g. a fee collection system promulgated by the E-Z Pass Interagency Group) currently in use on many toll roads and bridges in the northeast. In this model, utilities form a loose coalition with each utility using a basic common implementing technology enabling EV roamers to use the same EZ Charge capability throughout the subscribing utility network (SUN). Within the SUN, each member utility has its own billing and customer center; and all customer service centers are connected by a secure network. In an exemplary embodiment, each utility is responsible for paying any and all road improvement taxes associated with their sale of KWH for EV charging. As depicted in FIGS. 16 and 17, a group may include a manager 132, a local utility 120, the customer's home utility 122, and a company 134. In an exemplary embodiment, a commercial system manger 132 is engaged to develop and maintain the system required to handle the massive number of transactions occurring under the SUN EZ Pass business model.

A key difference between the SUN EZ Pass and the Utility Transaction Fee EZ Charge is that the SUN EZ Pass system is comprised of a limited number of agencies that own key transportation assets (e.g., toll roads). The EZ Pass system has approximately 25 participating agencies in its inter-agency group, each owning transportation assets. The equivalent inter-agency group in the SUN EZ Pass system is the participating utilities, however a key difference in the EZ Charge system is the existence of a multitude of independent charging station providers. In cities like New York or Los Angeles there may be a thousand independent charging companies 134. The manager 132 in combination with the local utility 120 will identify credits or abated rates as appropriate to large company and small company providers and embed these credits into their consolidated billings.

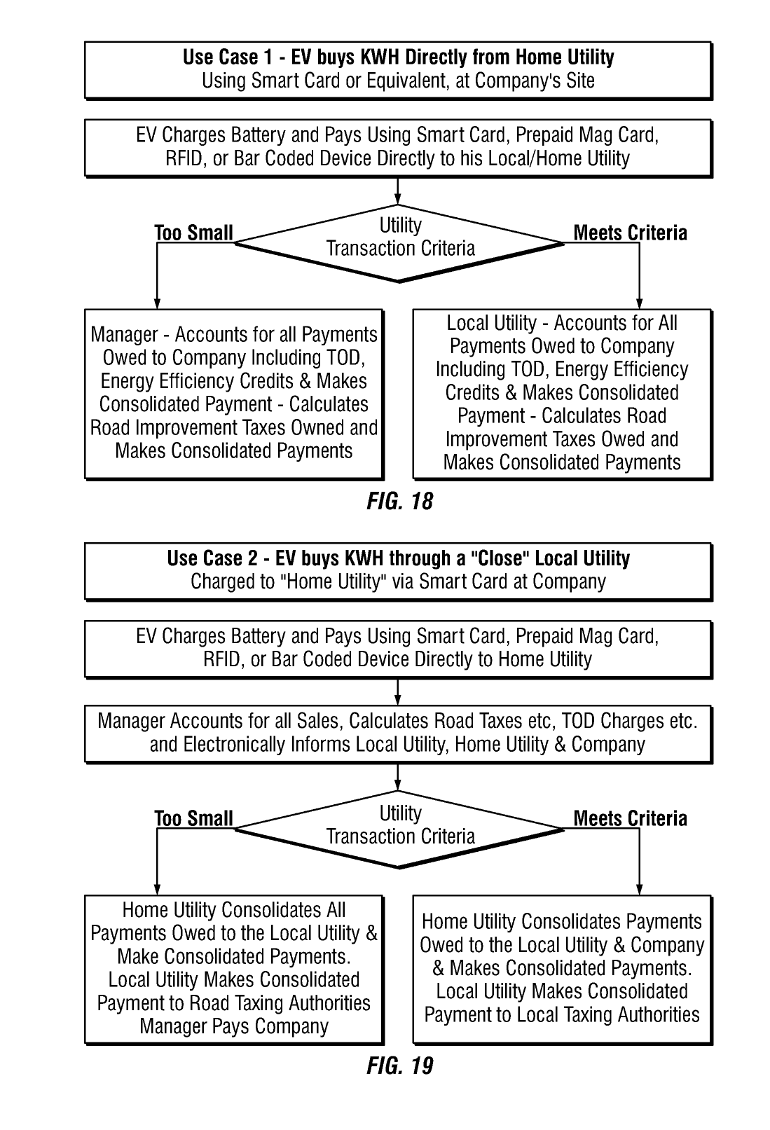

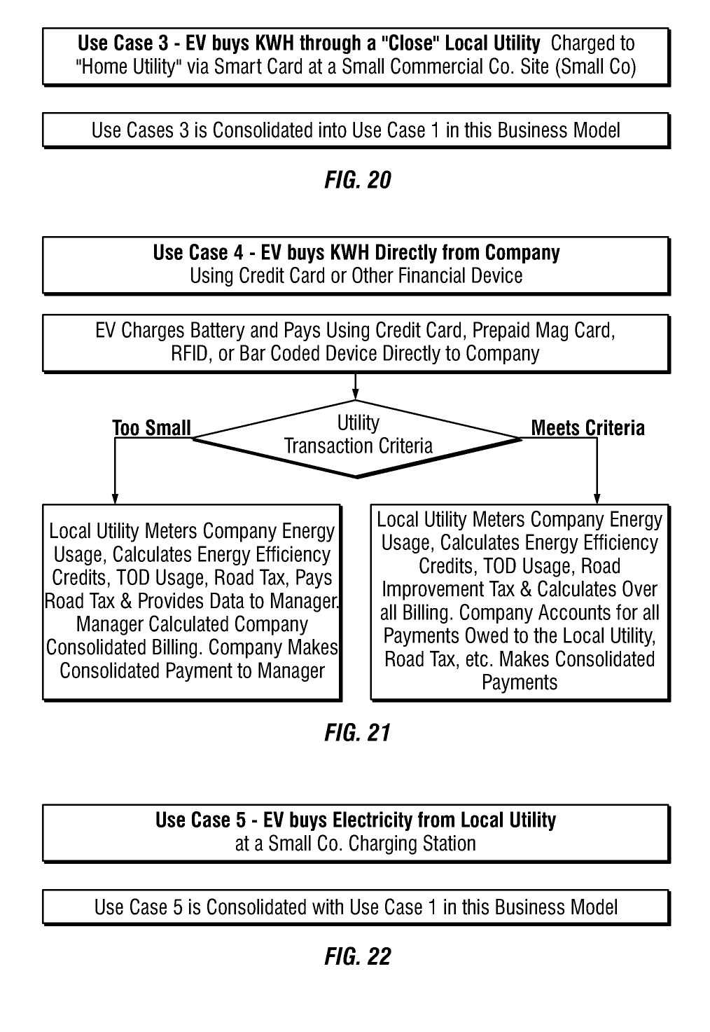

FIGS. 18-25 depict various use cases for the SUN EZ Pass process. The exemplary use cases described herein are illustrative of a family of use cases and do not represent all use cases covered by exemplary embodiments. FIG. 18 depicts a first exemplary use case, where an EV operator buys KWH directly from his home utility 122 using a smart card or equivalent, at a company site and the EV operator is a customer of the local utility 120. FIG. 19 depicts a second exemplary use case, where an EV operator buys KWH through a close local utility 120 and charges the purchase to a home utility 122 via a smart card at a company 134. FIG. 20 depicts a third exemplary use case, where an EV operator buys KWH through a close local utility 120 and charges the purchase to a home utility 122 via a smart card at a small company 134.

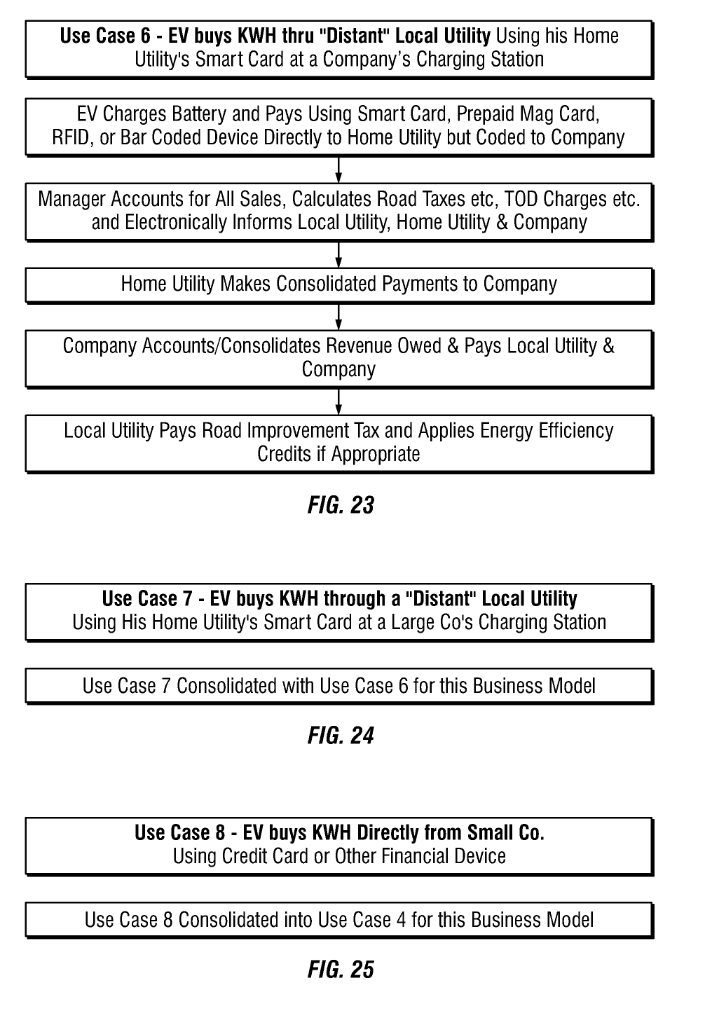

FIG. 21 depicts a fourth exemplary use case for the SUN EZ Pass process, where an EV operator buys KWH directly from a company 134 using a credit card or other financial device. FIG. 22 depicts a fifth exemplary use case, where an EV operator buys electricity from a local utility 120. FIG. 23 depicts a sixth exemplary use case, where an EV operator buys electricity from a distant local utility 120 using a smart card from his home utility 122, where the purchase is at a company's EVCS. FIG. 24 depicts a seventh exemplary use case, where an EV operator buys KWH through a distant local utility 120 using a smart card from his home utility 122, where the purchase is at a large company 134 EVCS. FIG. 25 depicts an eighth exemplary use case where an EV operator buys KWH directly from a small company 134 using a credit card or other financial device.

The third process described herein is the All Prepaid Transactions (APT) EZ Charge process. In this process, the EZ Charge is offered as a debit account with charging fees being deducted from prepayments. In addition, the consumer has the option of prepaying with cash at any of the companies or automatically prepaying using a credit card link from a direct charge to the consumer's credit card. In an exemplary embodiment, there is a limit for each automatic charge (e.g., $25, $50, $100) that is updated over time based on security and other considerations. The system includes a contactless charge mechanism (a tag, card or mobile device) which, when waived over a reading device (on EV charging equipment or stand alone reader), will deduct charges from the consumer's account and show a balance. The system provides the transaction processing and capability for dynamic pricing and offers from entities that join program (retailers, utilities). In this system, payment by credit card or debit card can be treated like a prepayment card. The system is designed for retailers, parking garages, cinemas, sporting events and arenas, and restaurants. The system may be used in conjunction with other utility sponsored programs or may serve the entire charging transaction system.

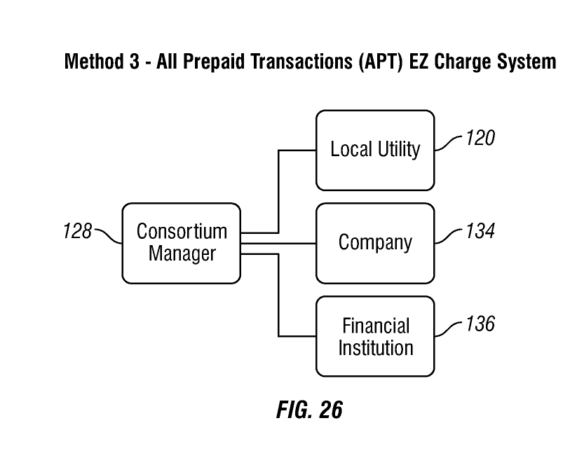

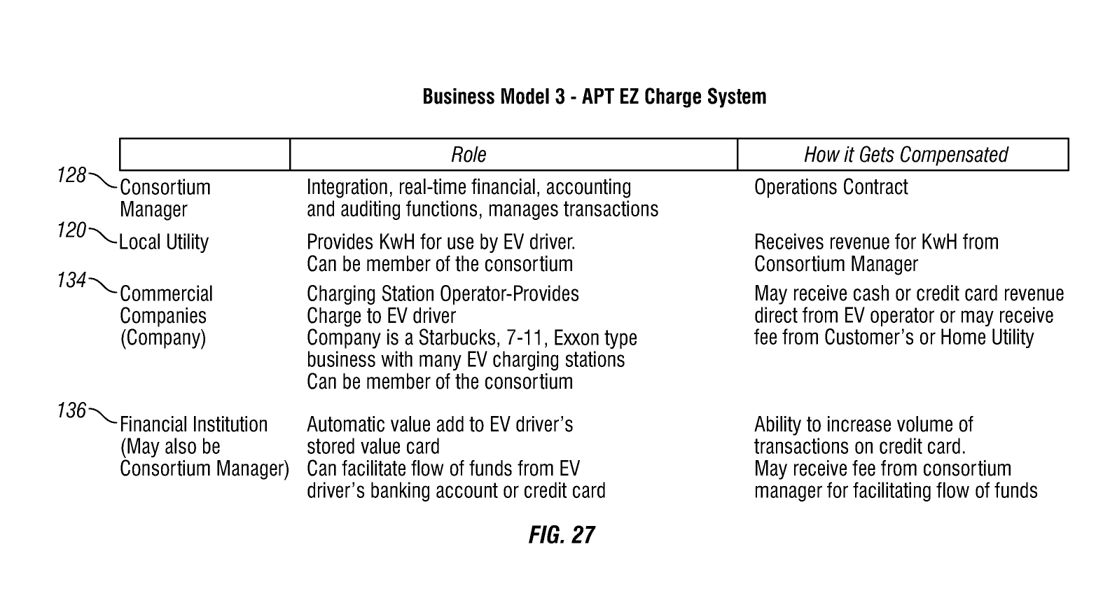

In the APT EZ Charge process, the utilities form a tight coalition with other participating APT EZ Charge utilities. In an exemplary embodiment, each utility uses the same technology enabling EV roamers to use the same APT EZ Charge capability throughout the utility network. In an exemplary embodiment, each utility has its own billing and customer service center; and all customer service centers are connected by a secure network. In addition, each utility is responsible for paying any and all road improvement taxes associated with their sale of KWH for EV charging. As depicted in FIGS. 26 and 27, a consortium manager 128 is engaged to develop and maintain the system required to handle the massive number of transactions. In addition, a financial institution 126 is engaged to manage the large number of financial transactions and interface to credit card, debit card or other financial devices. The consortium manager 128 and the financial institution 136 may be one and the same. The APT EZ Charge process may be the easiest of the three processes to manage owing to the elegance and simplicity of an all pre-paid environment.

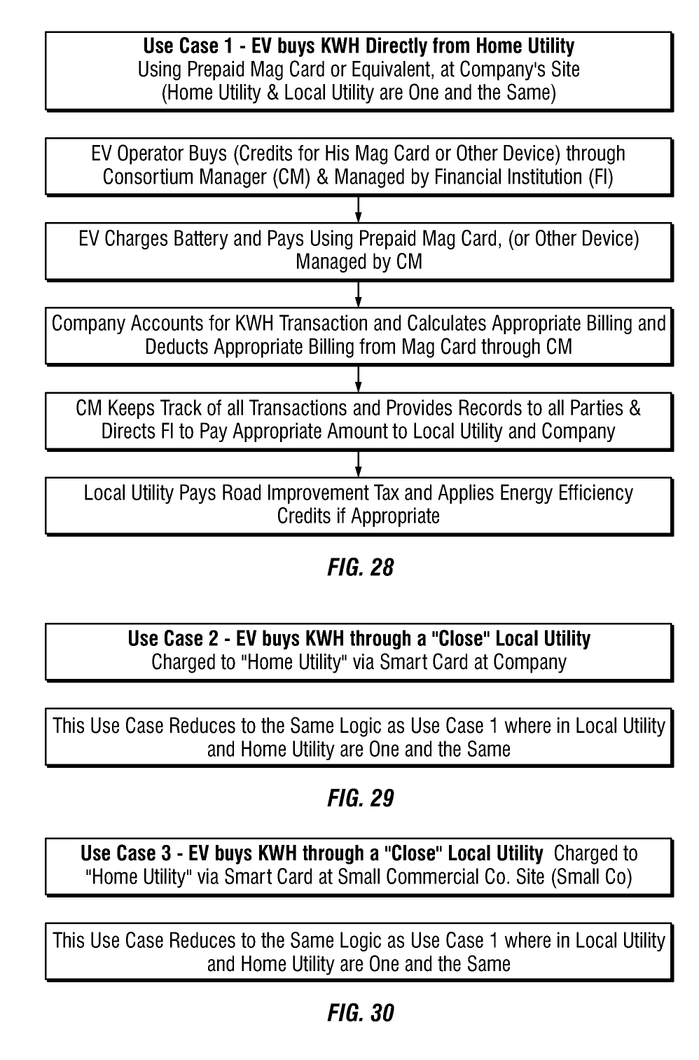

FIGS. 28-35 depict various exemplary use cases for the APT EZ Charge business model. The exemplary use cases described herein are illustrative of a family of use cases and do not represent all use cases covered by exemplary embodiments. FIG. 28 depicts a first exemplary use case, where an EV operator buys KWH directly from his home utility, the local utility 120, using a smart card or equivalent, at a company site. FIG. 29 depicts a second exemplary use case, where an EV operator buys KWH through a close local utility 120 and charges the purchase to a home utility via a smart card at a company 134. FIG. 30 depicts a third exemplary use case, where an EV operator buys KWH through a close local utility 120 and charges the purchase to a home utility via a smart card at a small company 134.

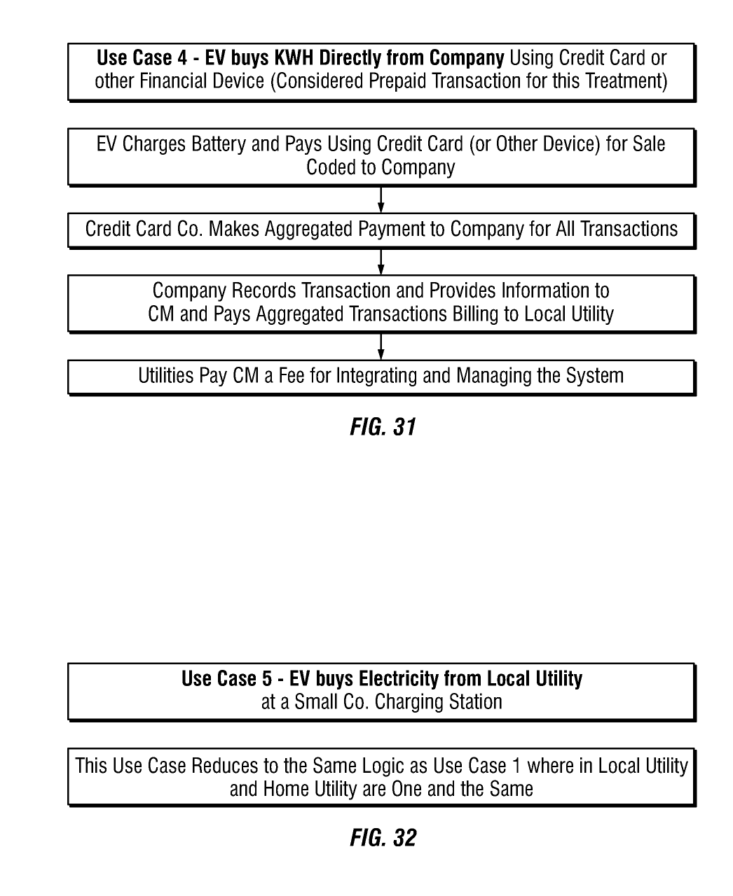

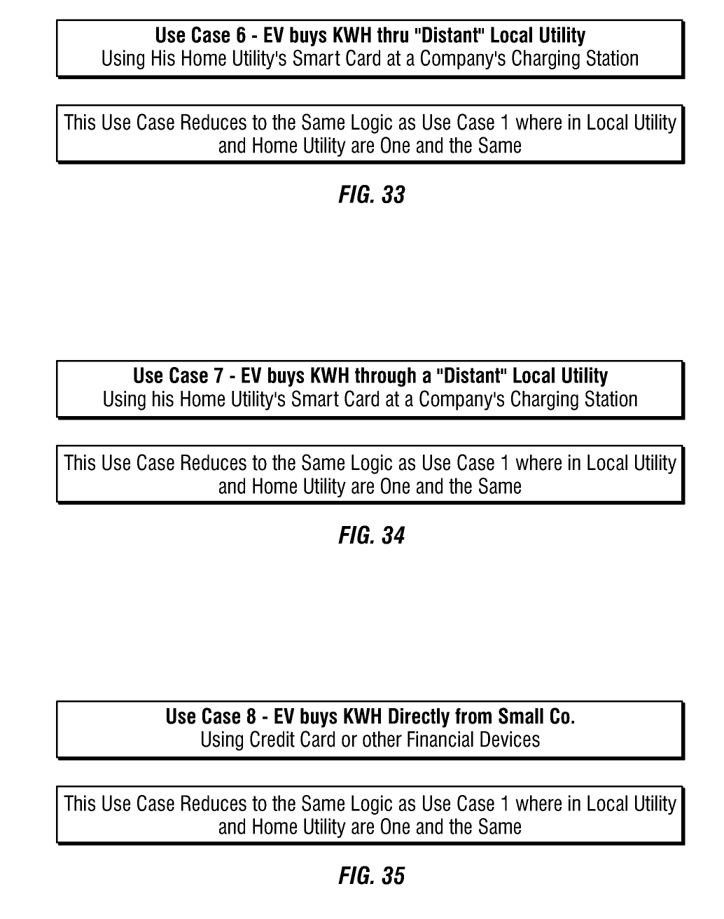

FIG. 31 depicts a fourth exemplary use case for the APT EZ Charge process, where an EV operator buys KWH directly from a company 134 using a credit card or other financial device. FIG. 32 depicts a fifth exemplary use case, where an EV operator buys electricity from a local utility 120. FIG. 33 depicts a sixth exemplary use case, where an EV operator buys electricity from a distant local utility 120 using a smart card from his home utility, where the purchase is at a company's EVCS. FIG. 34 depicts a seventh exemplary use case, where an EV operator buys KWH through a distant local utility 120 using a smart card from his home utility, where the purchase is at an EVCS managed by a large company 134. FIG. 35 depicts an eighth exemplary use case where an EV operator buys KWH directly from a small company 134 using a credit card or other financial device.

Exemplary embodiments provide a convenient manner for consumers to purchase items while waiting for a utility replenishment process to complete. By charging items directly to a utility account, a consumer can avoid having to wait in line to purchase the items, and the consumer does not need to carry extra cash or a credit card in order to make purchases.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A computer program product for charging purchases to utility accounts, the computer program product comprising:
a tangible storage medium readable by a processing circuit and storing instructions for execution by the processing circuit for performing a method comprising:
receiving a request from a consumer at an electric vehicle charging station to charge at least one of a purchase of electrical power for electric vehicle (EV) charging and an item other than electrical power to an electrical power utility account;
determining if the consumer is authorized to charge the purchase to the electrical power utility account;
transmitting a transaction denied message to the consumer in response to determining that the consumer is not authorized to charge the purchase to the electrical power utility account; and
in response to determining that the consumer is authorized to charge the purchase to the electrical power utility account:
charging the purchase to the electrical power utility account; and
transmitting a transaction completed message to the consumer.

2. The computer program product of claim 1, wherein the electrical power utility account includes billing information for electrical power usage at a residence or a business location.

3. The computer program product of claim 1, wherein the method further comprises:
receiving identifying data from the consumer; and
accessing security data associated with the electrical power utility account, wherein the identifying data and the security data are input to the determining.

4. The computer program product of claim 1, wherein the determining is responsive to at least one of a current payment status and a current balance of the electrical power utility account.

5. The computer program product of claim 1, wherein the request is received at a first computer associated with a first utility provider, and the electrical power utility account is associated with a second utility provider different from the first utility provider.

6. The computer program product of claim 1, wherein the item is a consumable item.

7. The computer program product of claim 1, wherein the item is a network connection service.

8. A method of charging purchases to utility accounts, the method comprising:
receiving a request from a consumer at an electric vehicle charging station to charge a purchase of at least one of electrical power for electric vehicle (EV) charging and an item other than electrical power to an electrical power utility account, the receiving at a host system via a network;
determining, at the host system, if the consumer is authorized to charge the purchase to the electrical power utility account;
transmitting a transaction denied message, via the network, to the consumer in response to determining that the consumer is not authorized to charge the purchase to the electrical power utility account; and
in response to determining that the consumer is authorized to charge the purchase to the electrical power utility account:
charging the purchase to the electrical power utility account; and
transmitting a transaction completed message, via the network, to the consumer.

9. The method of claim 8, wherein the electrical power utility account includes billing information for electrical power usage at a residence or a business location.

10. The method of claim 8, further comprising:
receiving identifying data from the consumer; and
accessing security data associated with the electrical power utility account, wherein the identifying data and the security data are input to the determining.

11. The method of claim 8, wherein the determining is responsive to at least one of a current payment status and a current balance of the electrical power utility account.

12. The method of claim 8, wherein the host system is associated with a first utility provider, and the electrical power utility account is associated with a second utility provider different from the first utility provider.

13. A computer program product for charging purchases to utility accounts, the computer program product comprising:
a tangible storage medium readable by a processing circuit and storing instructions for execution by the processing circuit for performing a method comprising:
receiving a request from a consumer to charge a purchase of an item other than a utility to a utility account;
determining if the consumer is authorized to charge the purchase to the utility account;
transmitting a transaction denied message, to the consumer in response to determining that the consumer is not authorized to charge the purchase to the utility account; and
in response to determining that the consumer is authorized to charge the purchase to the utility account:
charging the purchase to the utility account; and
transmitting a transaction completed message to the consumer.

14. The computer program product of claim 13, wherein the utility account includes billing information for utility usage at a residence or a business location.

15. The computer program product of claim 13, wherein the method further comprises:
receiving identifying data from the consumer; and
accessing security data associated with the utility account, wherein the identifying data and the security data are input to the determining.

16. The computer program product of claim 13, wherein the determining is responsive to at least one of a current payment status and a current balance of the utility account.

17. The computer program product of claim 13, wherein the request is received at a first computer associated with a first utility provider, and the utility account is associated with a second utility provider different from the first utility provider.

18. The computer program product of claim 13, wherein the item is a consumable item.

19. The computer program product of claim 13, wherein the item is a network connection service

20. A method of charging purchases to utility accounts, the method comprising:
receiving a request from a consumer to charge a purchase of an item other than a utility to a utility account, the receiving at a host system via a network;
determining, at the host system, if the consumer is authorized to charge the purchase to the utility account;
transmitting a transaction denied message, via the network, to the consumer in response to determining that the consumer is not authorized to charge the purchase to the utility account; and
in response to determining that the consumer is authorized to charge the purchase to the utility account:
charging the purchase to the utility account; and
transmitting a transaction completed message, via the network, to the consumer.

21. The method of claim 20, wherein the utility account includes billing information for utility usage at a residence or a business location.

22. The method of claim 20, further comprising:
receiving identifying data from the consumer; and
accessing security data associated with the utility account, wherein the identifying data and the security data are input to the determining.

23. The method of claim 20, wherein the determining is responsive to at least one of a current payment status and a current balance of the utility account.

24. The method of claim 20, wherein the host system is associated with a first utility provider, and the utility account is associated with a second utility provider different from the first utility provider.

25. A system for charging purchases to utility accounts, the system comprising:
a host computer; and
an application for execution on the host computer to implement a method comprising:
receiving a request from a consumer to charge a purchase of an item other than a utility to a utility account, the receiving via a network;
determining if the consumer is authorized to charge the purchase to the utility account;
transmitting a transaction denied message, via the network, to the consumer in response to determining that the consumer is not authorized to charge the purchase to the utility account; and
in response to determining that the consumer is authorized to charge the purchase to the utility account:
charging the purchase to the utility account; and
transmitting a transaction completed message, via the network, to the consumer.

26. The system of claim 25, wherein the utility account includes billing information for utility usage at a residence or a business location.

27. The system of claim 25, further comprising:
receiving identifying data from the consumer; and
accessing security data associated with the utility account, wherein the identifying data and the security data are input to the determining.

28. The system of claim 25, wherein the determining is responsive to at least one of a current payment status and a current balance of the utility account.

29. The system of claim 25, wherein the host system is associated with a first utility provider, and the utility account is associated with a second utility provider different from the first utility provider.

30. A method of charging purchases to utility accounts, the method comprising:
receiving a request from a consumer to charge a purchase of an item other than a utility to a utility account, the receiving via a user interface at a client system;
receiving identifying data about the consumer;
transmitting, via a network, the request and the identifying data to a host system;
receiving a status message from the host system, the status message one of a transaction completed message and a transaction denied message, the transaction completed message indicating that the purchase of the item was charged to the utility account and that the purchase of the item is complete, and the transaction denied message indicating that the purchase of the item was not charged to the utility account and that the purchase of the item is not complete; and
outputting the status message to the consumer via the user interface.

31. The method of claim 30, wherein the host system is associated with a first utility provider, and the utility account is associated with a second utility provider different from the first utility provider.

32. The method of claim 30 wherein the utility account is an electrical power utility account.

33. The method of claim 30, wherein the utility is electrical power and the client system is an electric vehicle charging station.

34. The method of claim 30, wherein the client system is a utility replenishment station.

35. The method of claim 30, wherein the utility account includes billing information for utility usage at a residence or a business location.

36. The method of claim 30, wherein the item is a consumable item.

37. The method of claim 30, wherein the item is wireless fidelity (WiFi) service.
